(19) United States
(12) Patent Application Publication
(10) Pub. No.: US 2026/0205911 A1
(43) Pub. Date: Jul. 16, 2026

(54) LATENCY-BASED HANDOVER

(71) Applicant: Nokia Solutions and Networks Oy, Espoo (FI)

(72) Inventors: Saeed Reza KHOSRAVIRAD, Murray Hill, NJ (US); Dong LI, Shanghai (CN); Paolo BARACCA, Munich (DE); Gilberto BERARDINELLI, Aalborg (DK)

(21) Appl. No.: 19/135,485

(22) PCT Filed: Dec. 5, 2022
(86) PCT No.: PCT/CN2022/136625

§ 371 Date: Jun. 4, 2025

(51) Int. Cl. H04W 36/30

(52) U.S. Cl. CPC H04W 36/304

(57) ABSTRACT

Disclosed is a method comprising determining, by an apparatus, whether a handover of a target user node of a plurality of user nodes would cause a latency of one or more links between the target user node and one or more other user nodes of the plurality of user nodes to be larger than a tolerable latency; selecting, by the apparatus, based at least partly on the determination, a subset of the plurality of user nodes for the handover, wherein the subset comprises at least the target user node; selecting, by the apparatus, a target access point from a plurality of access points for the handover; and transmitting, by the apparatus, to the subset of the plurality of user nodes, an indication for performing the handover from the apparatus to the target access point.

### FIELD

The following example embodiments relate to wireless communication.

### BACKGROUND

Some wireless communications applications may require low communications latency. Thus, it is desirable to provide solutions for reducing communications latency.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: determine whether a handover of a target user node of a plurality of user nodes would cause a latency of one or more links between the target user node and one or more other user nodes of the plurality of user nodes to be larger than a tolerable latency; select, based at least partly on the determination, a subset of the plurality of user nodes for the handover, wherein the subset comprises at least the target user node; select a target access point from a plurality of access points for the handover; and transmit, to the subset of the plurality of user nodes, an indication for performing the handover from the apparatus to the target access point.

According to another aspect, there is provided an apparatus comprising: means for determining whether a handover of a target user node of a plurality of user nodes would cause a latency of one or more links between the target user node and one or more other user nodes of the plurality of user nodes to be larger than a tolerable latency; means for selecting, based at least partly on the determination, a subset of the plurality of user nodes for the handover, wherein the subset comprises at least the target user node; means for selecting a target access point from a plurality of access points for the handover; and means for transmitting, to the subset of the plurality of user nodes, an indication for performing the handover from the apparatus to the target access point.

According to another aspect, there is provided a method comprising: determining, by an apparatus, whether a handover of a target user node of a plurality of user nodes would cause a latency of one or more links between the target user node and one or more other user nodes of the plurality of user nodes to be larger than a tolerable latency; selecting, by the apparatus, based at least partly on the determination, a subset of the plurality of user nodes for the handover, wherein the subset comprises at least the target user node; selecting, by the apparatus, a target access point from a plurality of access points for the handover; and transmitting, by the apparatus, to the subset of the plurality of user nodes, an indication for performing the handover from the apparatus to the target access point.

According to another aspect, there is provided a computer program comprising instructions which, when executed by an apparatus, cause the apparatus to perform at least the following: determining whether a handover of a target user node of a plurality of user nodes would cause a latency of one or more links between the target user node and one or more other user nodes of the plurality of user nodes to be larger than a tolerable latency; selecting, based at least partly on the determination, a subset of the plurality of user nodes for the handover, wherein the subset comprises at least the target user node; selecting a target access point from a plurality of access points for the handover; and transmitting, to the subset of the plurality of user nodes, an indication for performing the handover from the apparatus to the target access point.

According to another aspect, there is provided a computer readable medium comprising program instructions which, when executed by an apparatus, cause the apparatus to perform at least the following: determining whether a handover of a target user node of a plurality of user nodes would cause a latency of one or more links between the target user node and one or more other user nodes of the plurality of user nodes to be larger than a tolerable latency; selecting, based at least partly on the determination, a subset of the plurality of user nodes for the handover, wherein the subset comprises at least the target user node; selecting a target access point from a plurality of access points for the handover; and transmitting, to the subset of the plurality of user nodes, an indication for performing the handover from the apparatus to the target access point.

According to another aspect, there is provided a non-transitory computer readable medium comprising program instructions which, when executed by an apparatus, cause the apparatus to perform at least the following: determining whether a handover of a target user node of a plurality of user nodes would cause a latency of one or more links between the target user node and one or more other user nodes of the plurality of user nodes to be larger than a tolerable latency; selecting, based at least partly on the determination, a subset of the plurality of user nodes for the handover, wherein the subset comprises at least the target user node; selecting a target access point from a plurality of access points for the handover; and transmitting, to the subset of the plurality of user nodes, an indication for performing the handover from the apparatus to the target access point.

According to another aspect, there is provided a system comprising at least a target user node and an access point of a wireless communication network. The access point is configured to: determine whether a handover of the target user node of a plurality of user nodes would cause a latency of one or more links between the target user node and one or more other user nodes of the plurality of user nodes to be larger than a tolerable latency; select, based at least partly on the determination, a subset of the plurality of user nodes for the handover, wherein the subset comprises at least the target user node; select a target access point from a plurality of access points for the handover; and transmit, to the subset of the plurality of user nodes, an indication for performing the handover from the access point to the target access point. The target user node is configured to: receive the indication from the access point; and perform, based on the indication, the handover from the access point to the target access point.

According to another aspect, there is provided a system comprising at least a target user node and an access point of a wireless communication network. The access point comprises means for: determining whether a handover of the target user node of a plurality of user nodes would cause a latency of one or more links between the target user node and one or more other user nodes of the plurality of user nodes to be larger than a tolerable latency; selecting, based at least partly on the determination, a subset of the plurality of user nodes for the handover, wherein the subset comprises at least the target user node; selecting a target access point from a plurality of access points for the handover; and transmitting, to the subset of the plurality of user nodes, an indication for performing the handover from the access point to the target access point. The target user node comprises means for: receiving the indication from the access point; and performing, based on the indication, the handover from the access point to the target access point.

### LIST OF DRAWINGS

In the following, various example embodiments will be described in greater detail with reference to the accompanying drawings, in which

FIG. 1 illustrates an example of a cellular communication network;

FIG. 2A illustrates an example of an in-robot/in-production module subnetwork;

FIB. 2B illustrates an example of an in-vehicle subnetwork;

FIG. 2C illustrates an example of an in-body subnetwork;

FIG. 2D illustrates an example of an in-house subnetwork;

FIG. 3A illustrates an example of added end-to-end latency caused by a handover of a user device;

FIG. 3B illustrates an example of added end-to-end latency caused by a handover of a user device;

FIG. 4 illustrates a signaling diagram;

FIG. 5 illustrates a flow chart;

FIG. 6 illustrates a flow chart;

FIG. 7 illustrates a flow chart;

FIG. 8 illustrates an example of an access point channel quality list;

FIG. 9 illustrates an example of a user group list; and

FIG. 10 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

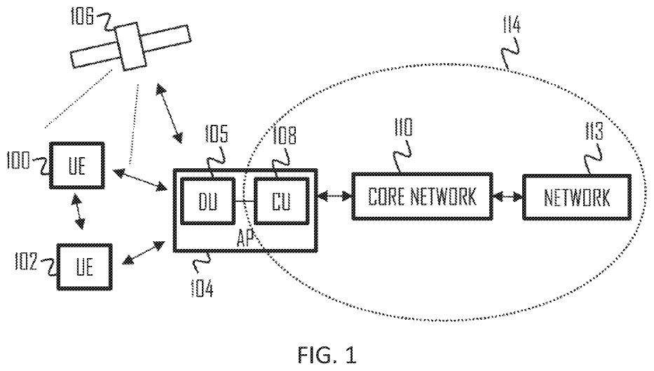

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access point (AP) 104, such as an evolved Node B (abbreviated as eNB or eNodeB) or a next generation Node B (abbreviated as gNB or gNodeB), providing the radio cell. The physical link from a user device to an access point may be called uplink (UL) or reverse link, and the physical link from the access point to the user device may be called downlink (DL) or forward link. A user device may also communicate directly with another user device via sidelink (SL) communication. It should be appreciated that access points or their functionalities may be implemented by using any node, host, server or access point etc. entity suitable for such a usage.

A communication system may comprise more than one access point, in which case the access points may also be configured to communicate with one another over links, wired or wireless, designed for the purpose. These links may be used for signaling purposes and also for routing data from one access point to another. The access point may be a computing device configured to control the radio resources of communication system it is coupled to. The access point may also be referred to as a base station, a base transceiver station (BTS), an access node, or any other type of interfacing device including a relay station capable of operating in a wireless environment. The access point may include or be coupled to transceivers. From the transceivers of the access point, a connection may be provided to an antenna unit that establishes bi-directional radio links to user devices. The antenna unit may comprise a plurality of antennas or antenna elements. The access point may further be connected to a core network 110 (CN or next generation core NGC). Depending on the deployed technology, the counterpart that the access point may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access point. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access point and forward it to a user device, and/or amplify a signal received from the user device and forward it to the access point.

The user device may also be called a subscriber unit, mobile station, remote terminal, access terminal, user terminal, user node, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or the like, providing facilities for networks of different operators to cooperate for example in spectrum sharing.

An access point may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access point. The DU 105 may be defined as a logical node hosting radio link control (RLC), medium access control (MAC) and/or physical (PHY) layers of the access point. The operation of the DU may be at least partly controlled by the CU. The CU may comprise a control plane (CU-CP), which may be defined as a logical node hosting the RRC and the control plane part of the PDCP protocol of the CU for the access point. The CU may further comprise a user plane (CU-UP), which may be defined as a logical node hosting the user plane part of the PDCP protocol and the SDAP protocol of the CU for the access point.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access point units, or different core network operations and access point operations, may differ.

Edge cloud may be brought into radio access network (RAN) by utilizing network function virtualization (NFV) and software defined networking (SDN). Using edge cloud may mean access point operations to be carried out, at least partly, in a server, host or node operationally coupled to a remote radio head (RRH) or a radio unit (RU), or an access point comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access point operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access point. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay node or by an access point 104 located on-ground or in a satellite.

It is obvious for a person skilled in the art that the depicted system is only an example of a part of a radio access system and in practice, the system may comprise a plurality of access points, the user device may have access to a plurality of radio cells and the system may also comprise other apparatuses, such as physical layer relay nodes or other network elements, etc. At least one of the access points may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access point(s) of FIG. 1 may provide any kind of these cells. A cellular radio system may be implemented as a multilayer network including several kinds of radio cells. In multilayer networks, one access point may provide one kind of a radio cell or radio cells, and thus a plurality of access points may be needed to provide such a network structure.

For fulfilling the need for improving the deployment and performance of communication systems, the concept of “plug-and-play” access points may be introduced. A network which may be able to use “plug-and-play” access points, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and controller functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

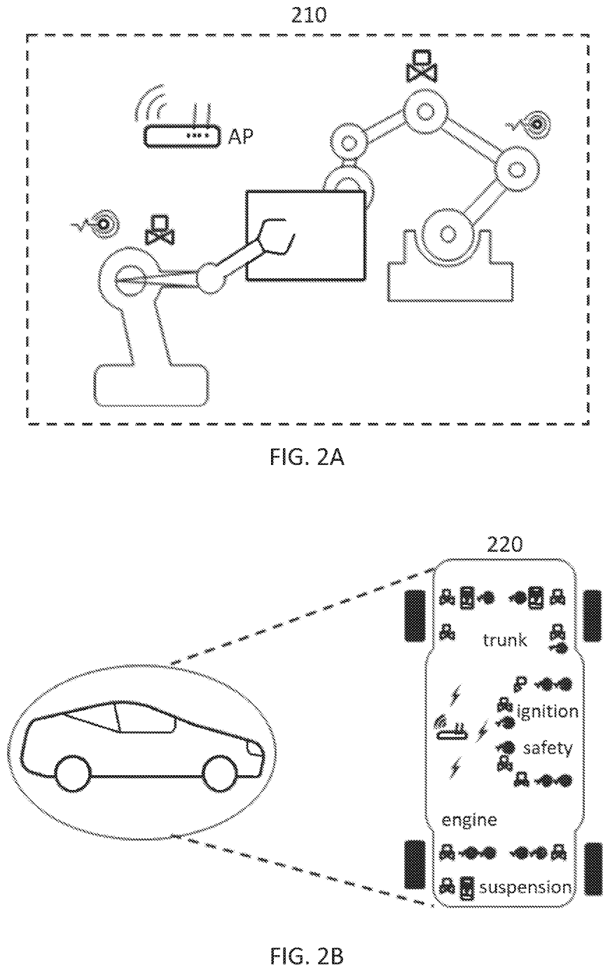

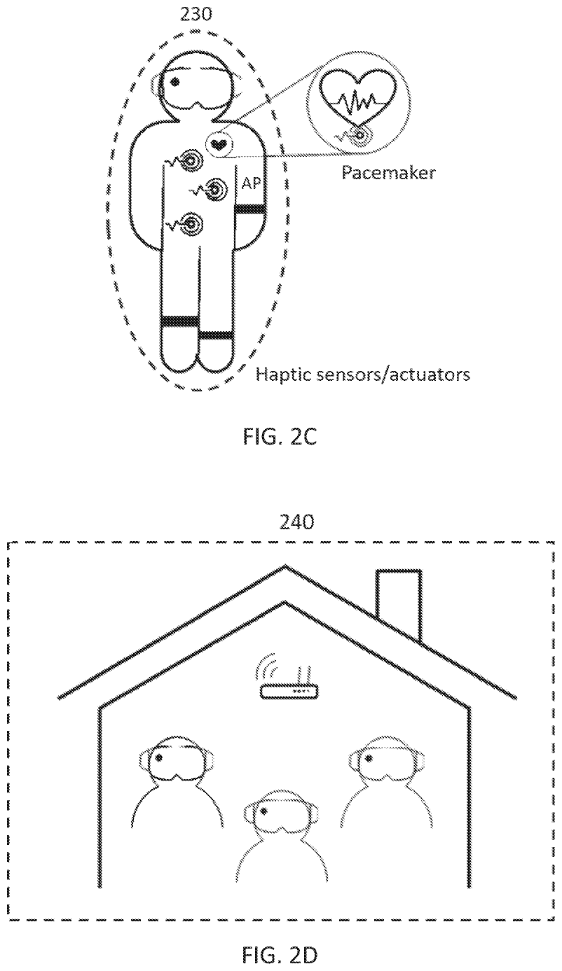

Some example embodiments relate to the context of in-X subnetworks with multi-AP architecture. In-X subnetworks are envisioned as a new network architecture paradigm for certain 6G short-range scenarios with high reliability and low latency requirements. Some examples of in-X subnetworks are shown in FIG. 2A, FIG. 2B, FIG. 2C, and FIG. 2D.

FIG. 2A illustrates an example of an in-robot/in-production module subnetwork 210.

FIB. 2B illustrates an example of an in-vehicle subnetwork 220.

FIG. 2C illustrates an example of an in-body subnetwork 230.

FIG. 2D illustrates an example of an in-house subnetwork 240.

Subnetworks may have the following properties and technical features: 1) support of extreme performance requirements in terms of latency, reliability and/or throughputs; 2) low transmit power, which implies limited coverage range (e.g., in the order of a few meters); 3) star or tree topology with one in-X AP and one or more in-X UEs under the AP's control; 4) overall mobility of AP and associated UEs, but lack/limited mobility across different subnetworks; 5) part of overlay wide area network (WAN), but needs to continue to work also when out of network coverage.

However, it should be noted that some example embodiments are not limited to in-X subnetworks, and they may be applicable to any wireless network in a cellular technology with multi-AP architecture, where low-latency communications is beneficial as part of the service.

In a multi-AP subnetwork, user nodes may be ideally connected to the AP with the best direct link. It may also be assumed that groups of user nodes performing the same task or connected to the same controller are located in vicinity to each other, and thus more likely to be connected to the same AP.

Herein the term “user node” refers to the user of a wireless communications. For example, a user node may comprise a user device (a.k.a. UE) or an edge function, such as a controller function (CF).

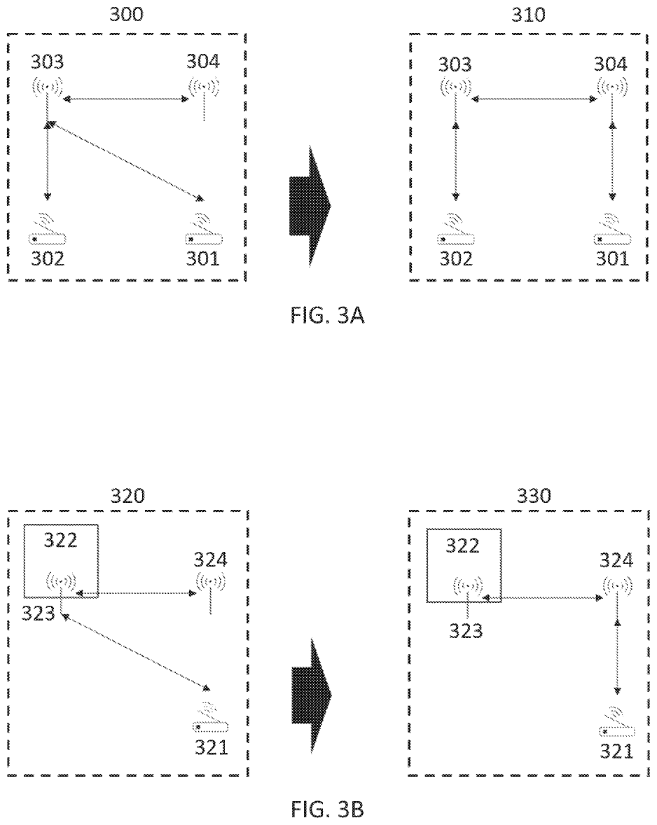

Some examples of end-to-end (E2E) traffic flows in subnetworks are illustrated in FIG. 3A and FIG. 3B.

FIG. 3A illustrates an example of added E2E latency caused by a handover of a user device. In FIG. 3A, a first user device 301 is communicating with a second user device 302 in the same subnetwork (these user devices may be, for example, sensors, controllers or actuators). The E2E traffic link between the two user devices 301, 302 is mediated by at least one primary AP 303, possibly with one or more other secondary APs 304 involved.

Referring to FIG. 3A, in block 300, an initial setup is performed with both user devices 301, 302 connected to the same AP 303, and E2E packet transmission between the user devices 301, 302 goes through one AP 303.

In block 310, the first user device 301 is handed over to another AP 304. As a result, the link between the two user devices 301, 302 experiences a longer E2E latency compared to block 300, since packets need to be exchanged between the two APs 303, 304 on their way between the user devices 301, 302.

FIG. 3B illustrates another example of added E2E latency caused by a handover of a user device. In FIG. 3B, a first user device 321 is communicating with a CF 322 that is located as an edge function at the primary AP 323. The edge function is a software-defined functionality, for example a software-defined direct current (DC) motor controller, which is located at the edge cloud, which in this case is the edge cloud at the primary AP 323.

Referring to FIG. 3B, in block 320, an initial setup is performed, where the controller function 322 for the first user device 321 is located at the serving AP 323 of the first user device 321.

In block 330, the first user device 321 is handed over from the AP 323 to another AP 324. As a result, the link between the first user device 321 and its controller function 322 experiences a longer E2E latency compared to block 320.

User nodes connected to the same AP may take advantage of low E2E latency, since the traffic among those user nodes can be handled by the edge processing in the connected AP. With natural variations in link quality, handover of one or more user nodes from one AP to another is a likely scenario in order to maintain reliability in the communications, for example in dynamic environments in presence of moving blockages, such as in industry motion control subnetworks.

By switching (handing over) one user node to a different AP, one additional communication hop and its imposed latency are added to the E2E latency experienced by the traffic. For example, in the case of FIG. 3B, since the CF 322 is still kept at the same AP 323, the E2E link between the user device 321 and the CF 322 spans over at least two channel hops after the user device 321 is handed over to a different AP 324. Therefore, for example in low latency use cases, it is beneficial to keep track of such handovers when a user node needs to be handed over between APs and a low E2E latency needs to be maintained.

Some example embodiments may address this issue and provide solutions based on the concept of ‘group handover’ to reduce operation latency for example for in-X subnetwork devices. However, it should be noted that some example embodiments are not limited to subnetworks, and they may be applied in any wireless communication network with mobile user nodes.

Some example embodiments may be used to monitor the need for group handover of user nodes (e.g., user devices and/or edge functions) based on channel quality and quality of service (QoS) requirements of the user nodes; minimize the volume of group handover requests by optimizing the subset of user nodes for handover and the choice of corresponding destination AP for the subset; and enforce handover for user nodes that may normally not need it (e.g., good channel quality based to the current serving AP) in order to provide system-level E2E low latency service.

Some example embodiments may be beneficial, for example, for subnetwork user nodes with stringent latency requirements. The existence of multiple subnetwork APs allows for better coverage and improved reliability (e.g., by multi-AP transmission/reception). With the simultaneous group handover, the additional latency imposed on a link during a handover operation may be reduced for all the user nodes in the same group. The group handover may be required for at least some of the user nodes in the same group with most stringent latency requirement.

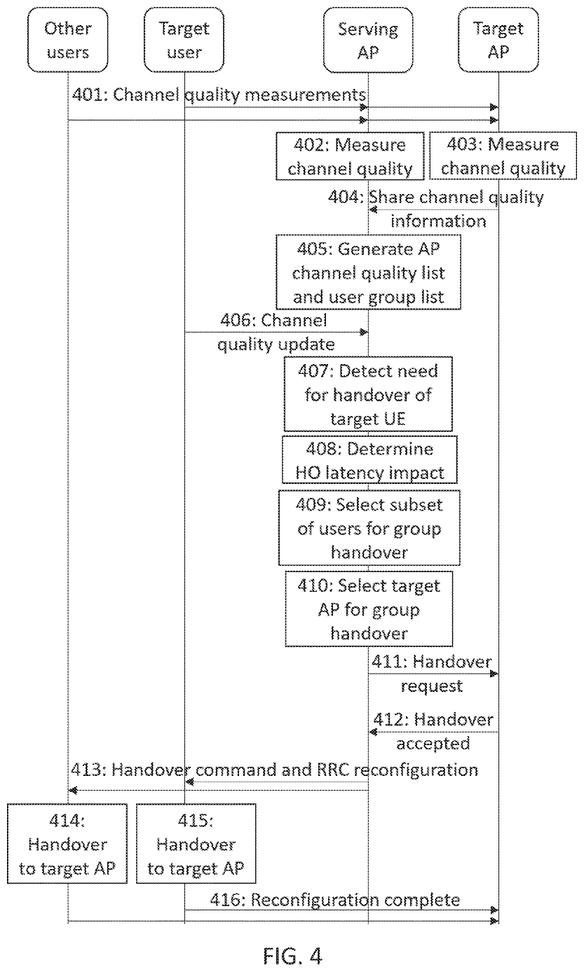

FIG. 4 illustrates a signaling diagram according to an example embodiment of the group handover operation for a multi-AP wireless subnetwork.

Referring to FIG. 4, in block 401, a plurality of user nodes in the subnetwork transmit measurement information to a serving AP. The serving AP may also share the measurement information with one or more other APs. The measurement information may indicate the channel quality between a given user node and one or more APs (e.g., the serving AP and/or the one or more other APs), and/or the channel quality between the plurality of user nodes.

Herein the term “user node” refers to the user of a wireless communications. For example, a user node may comprise a user device (a.k.a. UE) or an edge function, such as a CF.

In block 402, the serving AP measures its channel quality to the user nodes in the subnetwork. For example, the channel quality between the serving AP and a given user node may be measured when the user node transmits a pilot signal (reference signal) for which the received signal power is measured by the serving AP.

Herein the term “channel” refers to the wireless medium between two wireless devices (e.g., user nodes and APs).

In block 403, the one or more other APs in the subnetwork measure their channel quality to the user nodes in the subnetwork.

In block 404, the one or more other APs report, to the serving AP, information indicating channel qualities between the one or more other access points and the user nodes in the subnetwork. In other words, the serving AP may act as a central coordinator that collects the channel quality measurements from the APs in the subnetwork.

In block 405, the serving AP generates an AP channel quality list and a user group list. The AP channel quality list may also be referred to as a first list herein, and the user group list may also be referred to as a second list herein.

The AP link quality list may be generated centrally at the serving AP based on the channel quality measurements of the APs in the subnetwork. Alternatively, the AP channel quality list may be collected or generated separately at each AP. For example, each AP may measure its link quality to different user nodes, and the aggregated AP channel quality list may then be generated by sharing this information among the APs in the subnetwork. For example, this information exchange may be done periodically.

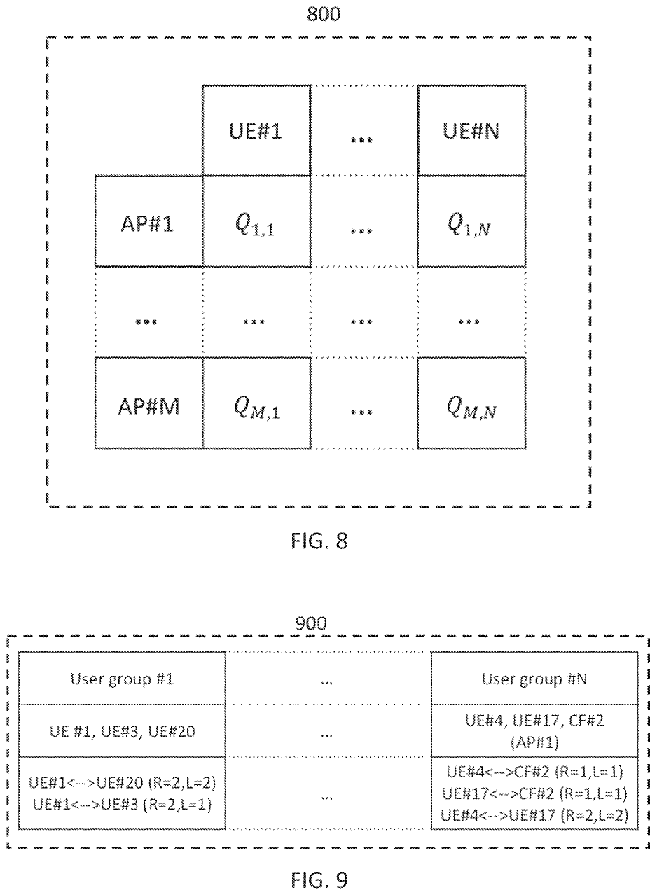

The AP channel quality list indicates the APs available in the subnetwork and the corresponding channel qualities between the APs and the user nodes in the subnetwork. The channel quality may be a time-variant quantity, which may be re-measured and updated according to the rate of variations. The AP channel quality list may be updated periodically or on-demand for one user node or a group of user nodes, for example upon determining to initiate a handover (HO) for one or more user nodes (i.e., when a handover for one or more user node(s) is deemed necessary). An example of the AP channel quality list is illustrated in FIG. 8.

The user group list indicates the user nodes in one or more user groups, and a plurality of links between the plurality of user nodes in a given user group. The user group list may further indicate, per link of the plurality of links between the plurality of user nodes, a first value (denoted as R) indicating the tolerable latency of the link, and a second value (denoted as L) indicating the latency of the link. An example of the user group list is illustrated in FIG. 9.

For example, the user group list may be generated by using an interface between an enterprise controller and the serving AP, wherein the enterprise controller knows which user nodes are in the same group and what links are established among them. Additionally, in some cellular networks, when a traffic link is established, for example at the transmission control protocol (TCP) internet protocol (IP) level between two user nodes, the core network may be able to track this and share this information with radio network nodes (e.g., the serving AP). In the case of subnetworks, most of the traffic may be handled “locally”, which means that an underlying protocol similar to TCP IP may be used to establish the links between user nodes. An interfacing between this protocol and the serving AP's scheduler may be used for collecting the user group list information.

Herein the term “link” refers to the E2E traffic link between two user nodes, for example between two user devices or between a user device and an edge function. Herein the term “traffic” may refer to data traffic.

A given user group may comprise one or more user devices and/or one or more edge functions which are communicating with each other. For example, a motion control user group may comprise a CF, where the CF is connected to, and in control of, one or more actuator/sensor user devices. The CF and the user device(s) connected to it may form one user group. Note that a wireless network (including a subnetwork) may be serving one or more user groups.

Each link in the user group (e.g., a link between an actuator user device and a CF, or a link between two user devices) may be assigned a value pair of (R,L), where R is the tolerable latency, for example the tolerable number of communication hops given the required E2E latency of the traffic link, and L is the actual latency in the link, for example the number of hops that each packet is actually travelling for communication between the two ends of the link (e.g., for 1 ms latency requirement R=2 hops may be tolerated, while for 0.5 ms latency R=1 hop may tolerated). The objective is to have L≤R for all the links.

The user group list may be updated based on a traffic link being added (initiated) or removed (terminated) in the subnetwork, or based on a user node being added to or removed from the subnetwork.

In block 406, a target user node transmits a channel quality update to the serving AP. Herein the term “target user node” refers to a user node to be handed over to another AP from the serving AP. The channel quality report transmitted by the user nodes may be updated periodically or on-demand, given the time-variant nature of the channel. If the channel quality update indicates degraded channel quality, a handover may be needed.

In block 407, based on the channel quality update, the serving AP detects a need for a handover of the target user node to another AP. For example, the serving AP may detect the need for the handover, when the channel from the target user node to the serving AP is estimated or measured as a poor channel.

In block 408, the serving AP determines whether the handover of the target user node would cause a latency of one or more links between the target user node and one or more other user nodes of the same user group to be larger than a tolerable latency.

In block 409, based on the determination of block 408, the serving AP selects, or identifies, a subset of user nodes from the user group for a simultaneous group handover. The subset of user nodes comprises at least the target user node, and possibly also one or more other user nodes from the same user group. The subset of user nodes may be selected based at least partly on the user group list (second list).

The subset of user nodes may be called a ‘target HO list’ herein, and it may be selected to minimize the number of handovers, while guaranteeing L≤R for all links and AP channel quality above a desired threshold for all user nodes in the subnetwork.

For example, if the handover of the target user node would result in one or more of the links to satisfy L>R (i.e., with the resulting latency after the handover being larger than the tolerable latency), then a subset of user nodes in the user group may be identified accordingly, and a simultaneous group handover for those user nodes is initiated by the subnetwork. In other words, the subset of user nodes may be selected to comprise the target user node and the one or more other user nodes based on determining that the handover of the target user node would cause the latency of the one or more links between the target user node and the one or more other user nodes to be larger than the tolerable latency. The serving AP may enforce the handover for the one or more other user nodes even though they may not otherwise need it, i.e., the channel quality between the serving AP and the one or more other user nodes may be above a channel quality threshold.

Alternatively, the subset of user nodes may be selected to comprise only the target user node based on determining that the handover of the target user node would not cause the latency of the one or more links between the target user device and the one or more other user nodes to be larger than the tolerable latency.

In block 410, the serving AP selects, or identifies, a target AP for the group handover based on the AP channel quality list (first list). If, as a result of the handover, all links (for the same user group where the target user node belongs to) satisfy L≤R, then the best AP for the handover of the target user node may be identified based on the AP channel quality list for the target user node. In other words, the target access point may be selected by comparing channel qualities between the target user node and the plurality of access points in the AP channel quality list and selecting an access point with a highest channel quality among the plurality of access points. The target AP refers to the AP, to which the subset of user nodes is handed over from the serving AP.

In block 411, the serving AP transmits a handover request to the target AP for requesting a handover of the subset of user nodes from the serving AP to the target AP. In case an edge function (e.g., a CF) is in the target HO list for group handover, the serving AP may also provide the function attributes and required stored data for the edge function to the target AP (e.g., over a wireless connection between the APs).

In block 412, the target AP transmits a response message to the serving AP to indicate that the handover is accepted.

In block 413, the serving AP transmits an indication, for example a handover command and an RRC reconfiguration, to the subset of user nodes (e.g., the target user node and the one or more other user nodes) for performing the handover of the subset of user nodes from the serving AP to the target AP.

In block 414, based on the indication, the target user node performs a handover from the serving AP to the target AP.

In block 415, based on the indication, the one or more other user nodes perform a handover from the serving AP to the target AP (if they were indicated to do so).

In block 416, the subset of user nodes transmit a reconfiguration complete message to the target AP to indicate that the handover is successfully completed.

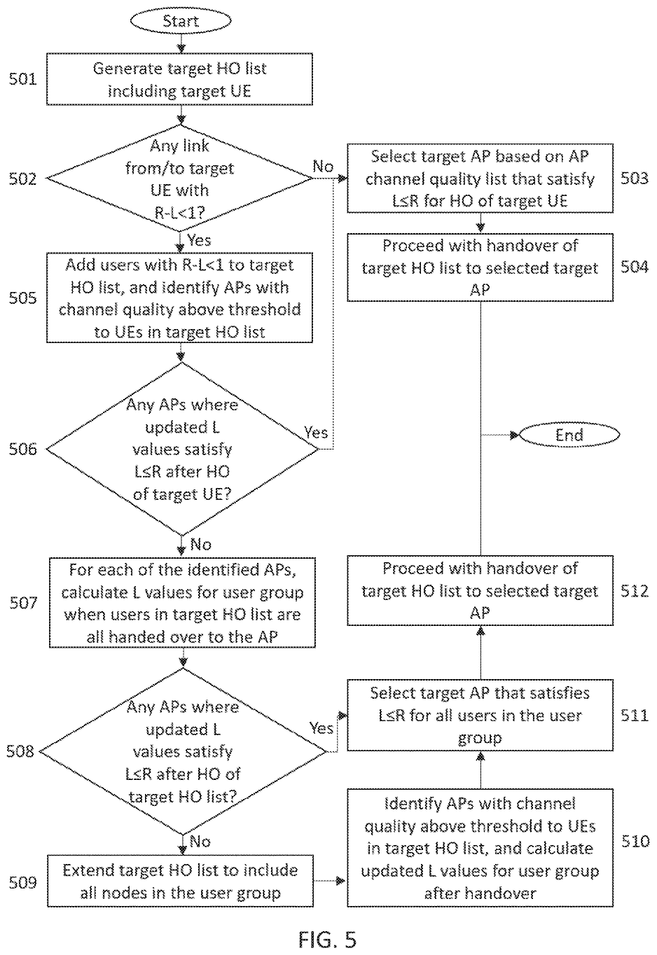

FIG. 5 illustrates a flow chart according to an example embodiment of an algorithm for selecting the subset of user nodes and the target AP for the handover. For example, the algorithm may be executed at the serving access point of FIG. 4 for identifying the subset of user nodes in block 408 and for identifying the target AP in block 409.

When there is a need for a handover of one user node, here called target user node, in the subnetwork from one AP to another, the subnetwork should guarantee that the E2E link will satisfy the E2E latency requirements after the handover is done. Thus, the subnetwork may anticipate the changes in E2E latency of the links before the actual handover is performed. Therefore, the calculations of the R and L values for the links may be calculated in anticipation of finding the best handover arrangement. If, as a result of the handover, one or more of the links satisfy L>R (i.e., the resulting latency is larger than the tolerable latency), then further action may be required by the subnetwork.

To this end, a subset (target HO list) of the user nodes in the user group of the target user node may be identified, and a simultaneous group handover for those user nodes may be initiated by the subnetwork. The subset may include the target user node, or the target user node and one or more other user nodes in the user group, or all of the user nodes in the user group. The subset may be selected to minimize the number of handovers, while guaranteeing L≤R for all links, and AP channel quality above a desired threshold for all user nodes.

It should be noted that FIG. 5 illustrates just one example embodiment for realizing such constraints, and different algorithms than the one illustrated in FIG. 5 may also be used to realize such constraints.

Referring to FIG. 5, in block 501, a ‘target HO list’ is generated, wherein the target HO list initially comprises the target user node. Over iterations, other user nodes from the user group of the target user node may be added to the target HO list. The goal is to keep the list as small as possible to reduce the handover load. By the end of the algorithm, all the user nodes in the target HO list will be handed over together. The goal of the algorithm is to find an AP satisfying at least the following conditions: channel quality above a desired threshold for all user nodes in the target HO list; and all user nodes in the user group to satisfy updated L≤R. If such an AP cannot be found, then all the nodes in the target group may be handed over together.

In block 502, the algorithm searches the user group list for the links to and from the target user node with R−L<1.

If none of the links to/from the target user node have R−L<1 (block 502: no), then the target HO list will only comprise the target user node, and the algorithm proceeds to block 503 followed by block 504, i.e., a handover to the best AP for the target user node is performed, and the L values for the links may be updated based on the handover arrangement. Otherwise, if one or more of the links to/from the target user node have R−L<1 (block 502: yes), the algorithm proceeds to block 505.

In block 503, based on the AP channel quality list, a proper target AP for the handover is selected that satisfies L≤R for the handover of the target user node.

In block 504, a handover of the user node(s) in the target HO list to the selected target AP is initiated.

In block 505, the algorithm adds one or more other user nodes to the ‘target HO list’ based on determining that the handover of the target user node would cause the latency of one or more links between the target user node and the one or more other user nodes to be larger than the tolerable latency (R−L<1). The algorithm identifies, from the plurality of access points in the channel quality list, one or more candidate access points with channel quality to the user nodes in the ‘target HO list’ above a desirable threshold. The algorithm calculates updated L values of the links for the user nodes in the ‘target HO list’ for when the target user node is handed over to each of the one or more APs.

Some examples for updating the L values are provided in FIG. 3A and FIG. 3B. The L value may correspond to the actual number of communication hops that the link between two user nodes 301, 302, 321, 322 needs to travel through. Therefore, as handovers happen, the association of user nodes to APs also change, which means that the L value for a given traffic link may change as well. The update here means accounting for such change after the handover. For example, in block 300 of FIG. 3A, there is one communication hop via AP 303 in the link between the two user nodes 301, 302, and therefore the L value of the link between the two user nodes 301, 302 may be one. In block 310 of FIG. 3A, after a handover of the user node 301 to another AP 304, there are two communication hops via two APs 303, 304 in the link between the two user nodes 301, 302, and therefore the updated L value of the link between the two user nodes 301, 302 may be two.

In block 506, the algorithm determines whether there are any APs among the identified one or more APs for which the updated L values satisfy L≤R for all links of the user nodes in the user group after the handover of the target user node.

If such an AP is found (block 506: yes), then the algorithm proceeds to block 503 followed by block 504, i.e., a handover of the user nodes in the target HO list to the selected AP is initiated. Otherwise, if no such AP is found (block 506: no), then the algorithm proceeds to block 507.

In block 507, for each of the identified one or more candidate APs, the algorithm calculates updated L values of the links of the user group for when the user nodes in the ‘target HO list’ are all handed over to the same AP.

In block 508, the algorithm determines whether there are any APs among the identified one or more candidate APs, for which the updated L values (of block 507) satisfy L≤R for all links of the user nodes in the user group after the handover of the user nodes in the ‘target HO list’.

If such an AP is found (block 508: yes), then the algorithm proceeds to block 511 followed by block 512, i.e., a handover of all user nodes in the ‘target HO list’ to the selected AP is initiated. Otherwise, if no such AP is found (block 508: no), the algorithm proceeds to block 509.

In block 509, the algorithm includes all user nodes in the user group into the ‘target HO list’ and proceeds to block 510 followed by block 511 and block 512. In this case, a simultaneous handover of all the user nodes in the user group is initiated to one AP that satisfies the channel quality requirement for all the user nodes in the user group.

In block 510, the algorithm identifies, from the plurality of access points in the AP channel quality list, one or more candidate access points with channel quality to the user nodes in the target HO list (i.e., the whole user group) above the threshold, and calculates updated L values for the user group for after the handover.

In block 511, one target AP that satisfies L≤R for all user nodes in the user group is selected from the one or more APs identified in block 508 or block 510. In other words, the target access point may be selected from the one or more candidate access points based on determining that the handover of the users in the target HO list to the target access point would cause a latency of all links between the user nodes in the user group to be smaller than or equal to the tolerable latency.

In block 512, a handover of the user nodes in the target HO list to the selected target AP is initiated.

It should be noted that the algorithm above assumes that the deployment of APs in the network is done so as to provide a choice of AP to satisfy the QoS constraints with the dynamics of the environment in mind. If such choice of AP is not available, the problem may be considered to be unfeasible, and the operation may stop.

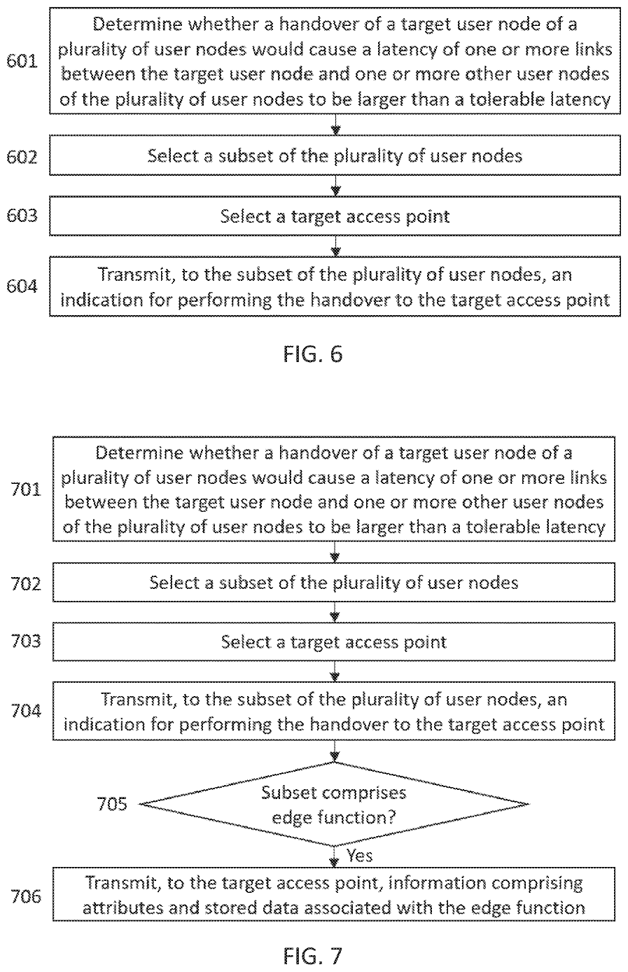

FIG. 6 illustrates a flow chart according to an example embodiment of a method performed by an apparatus. For example, the apparatus may be, or comprise, or be comprised in, a network element of a wireless communication network. The network element may correspond to the access point 104 of FIG. 1, or the AP 303 of FIG. 3A, or the AP 323 of FIG. 3B, or the serving AP of FIG. 4.

Referring to FIG. 6, in block 601, the apparatus determines whether a handover of a target user node of a plurality of user nodes would cause a latency of one or more links between the target user node and one or more other user nodes of the plurality of user nodes to be larger than a tolerable latency.

For example, the plurality of user nodes may comprise at least one of the following: a plurality of user devices, or one or more edge functions and one or more user devices. The apparatus, the plurality of access points, and the plurality of user nodes may be in a same subnetwork.

In block 602, the apparatus selects, based at least partly on the determination, a subset of the plurality of user nodes for the handover, wherein the subset comprises at least the target user node.

For example, the subset of the plurality of user nodes may be selected to comprise the target user node based on determining that the handover of the target user node would not cause the latency of the one or more links to be larger than the tolerable latency.

As another example, the subset of the plurality of user nodes may be selected to comprise the target user node and the one or more other user nodes based on determining that the handover of the target user node would cause the latency of the one or more links to be larger than the tolerable latency.

In block 603, the apparatus selects a target access point from a plurality of access points for the handover.

In block 604, the apparatus transmits, to the subset of the plurality of user nodes, an indication for performing the handover from the apparatus to the target access point.

FIG. 7 illustrates a flow chart according to an example embodiment of a method performed by an apparatus. For example, the apparatus may be, or comprise, or be comprised in, a network element of a wireless communication network. The network element may correspond to the access point 104 of FIG. 1, or the AP 303 of FIG. 3A, or the AP 323 of FIG. 3B, or the serving AP of FIG. 4.

Referring to FIG. 7, in block 701, the apparatus determines whether a handover of a target user node of a plurality of user nodes would cause a latency of one or more links between the target user node and one or more other user nodes of the plurality of user nodes to be larger than a tolerable latency.

For example, the plurality of user nodes may comprise at least one of the following: a plurality of user devices, or one or more edge functions and one or more user devices. The apparatus, the plurality of access points, and the plurality of user nodes may be in a same subnetwork.

In block 702, the apparatus selects, based at least partly on the determination, a subset of the plurality of user nodes for the handover, wherein the subset comprises at least the target user node.

For example, the subset of the plurality of user nodes may be selected to comprise the target user node based on determining that the handover of the target user node would not cause the latency of the one or more links to be larger than the tolerable latency.

As another example, the subset of the plurality of user nodes may be selected to comprise the target user node and the one or more other user nodes based on determining that the handover of the target user node would cause the latency of the one or more links to be larger than the tolerable latency.

In block 703, the apparatus selects a target access point from a plurality of access points for the handover.

In block 704, the apparatus transmits, to the subset of the plurality of user nodes, an indication for performing the handover from the apparatus to the target access point.

In block 705, the apparatus determines whether the subset of the plurality of user nodes comprises at least one edge function.

In block 706, based on determining that the subset comprises the at least one edge function (block 705: yes), the apparatus transmits, to the target access point, information comprising attributes and stored data associated with the at least one edge function.

The blocks, related functions, and information exchanges (messages) described above by means of FIGS. 4-7 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIG. 8 illustrates an example of an AP channel quality list 800. In FIG. 8, N user nodes and M APs are listed, and the channel quality between user node n and AP m is indicated as an entry denoted by Q_{m,n}. The type of the channel quality may vary depending on the embodiment. For example, the entry Q_{m,n} may indicate reference signal received power (RSRP), signal-to-interference-plus-noise ratio (SINR), and/or large scale fading (average RSRP over time and frequency).

FIG. 9 illustrates an example of a user group list 900. In FIG. 9, CF#y(AP#x) denotes the controller function number y, which is located at AP number x.

In subnetworks, the data flows among user nodes may be initiated for specific functions. For example, as mentioned above, the E2E link between a controller device and an actuator device, as well as the link between sensors and the same controller device, may be established for the purpose of a motion control operation. In this context, groups of user nodes in the subnetwork may be formed in the communications world based on a shared underlying function in the physical world. Herein those user groups are assumed to be disjoint. For the case of groups with shared user nodes, some example embodiments may be applied by merging those groups or by operating some example embodiments iteratively on those groups to make sure that the E2E latencies will stay below the required level.

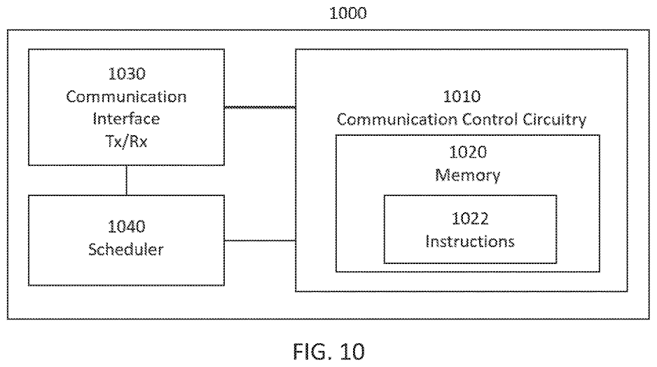

FIG. 10 illustrates an example of an apparatus 1000 comprising means for performing one or more of the example embodiments described above. For example, the apparatus 1000 may be an apparatus such as, or comprising, or comprised in, a network element of a wireless communication network. For example, the wireless communication network may refer to a radio access network. The network element may correspond to the access point 104 of FIG. 1, or the AP 303 of FIG. 3A, or the AP 323 of FIG. 3B, or the serving AP of FIG. 4. The network element may also be referred to, for example, as a network node, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1000 may comprise, for example, a circuitry or a chipset applicable for realizing one or more of the example embodiments described above. The apparatus 1000 may be an electronic device comprising one or more electronic circuitries. The apparatus 1000 may comprise a communication control circuitry 1010 such as at least one processor, and at least one memory 1020 storing instructions 1022 which, when executed by the at least one processor, cause the apparatus 1000 to carry out one or more of the example embodiments described above. Such instructions 1022 may, for example, include a computer program code (software), wherein the at least one memory and the computer program code (software) are configured, with the at least one processor, to cause the apparatus 1000 to carry out one or more of the example embodiments described above. The at least one processor and the at least one memory storing the instructions may provide the means for providing or causing the performance of any of the methods and/or blocks described above.

The processor is coupled to the memory 1020. The processor is configured to read and write data to and from the memory 1020. The memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1020 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1000 may further comprise a communication interface 1030 comprising hardware and/or software for realizing communication connectivity according to one or more communication protocols. The communication interface 1030 comprises at least one transmitter (Tx) and at least one receiver (Rx) that may be integrated to the apparatus 1000 or that the apparatus 1000 may be connected to. The communication interface 1030 may provide means for performing some of the blocks for one or more example embodiments described above. The communication interface 1030 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1030 provides the apparatus with radio communication capabilities to communicate in the cellular communication system. The communication interface may, for example, provide a radio interface to one or more user nodes. The apparatus 1000 may further comprise another interface towards a core network such as the network coordinator apparatus or AMF, and/or to the access points of the cellular communication system.

The apparatus 1000 may further comprise a scheduler 1040 that is configured to allocate radio resources. The scheduler 1040 may be configured along with the communication control circuitry 1010 or it may be separately configured.

It is to be noted that the apparatus 1000 may further comprise various components not illustrated in FIG. 10. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1. An apparatus comprising at least one processor, and at least one memory storing instructions that, when executed by the at least one processor, cause the apparatus at least to:
determine whether a handover of a target user node of a plurality of user nodes would cause a latency of one or more links between the target user node and one or more other user nodes of the plurality of user nodes to be larger than a tolerable latency;
select, based at least partly on the determination, a subset of the plurality of user nodes for the handover, wherein the subset comprises at least the target user node;
select a target access point from a plurality of access points for the handover; and
transmit, to the subset of the plurality of user nodes, an indication for performing the handover from the apparatus to the target access point.

2. The apparatus according to claim 1, wherein the target access point is selected by comparing channel qualities between the target user node and the plurality of access points and selecting an access point with a highest channel quality among the plurality of access points.

3. The apparatus according to claim 1, wherein the subset of the plurality of user nodes is selected to comprise the target user node based on determining that the handover of the target user node would not cause the latency of the one or more links to be larger than the tolerable latency.

4. The apparatus according to claim 1, wherein the subset of the plurality of user nodes is selected to comprise the target user node and the one or more other user nodes based on determining that the handover of the target user node would cause the latency of the one or more links to be larger than the tolerable latency.

5. The apparatus according to claim 4, further being caused to:
identify, from the plurality of access points, one or more candidate access points with channel quality to the subset of the plurality of user nodes above a threshold,
wherein the target access point is selected from the one or more candidate access points based on determining that the handover of the subset of the plurality of user nodes to the target access point would cause a latency of all links between the plurality of user nodes to be smaller than or equal to the tolerable latency.

6. The apparatus according to claim 5, wherein channel quality between the apparatus and the one or more other user nodes is above the threshold.

7. The apparatus according to claim 1, further being caused to:
receive, from the plurality of access points, information indicating channel qualities between the plurality of access points and the plurality of user nodes; and
generate, based on the information, a first list indicating the channel qualities between the plurality of access points and the plurality of user nodes, wherein the target access point is selected based at least partly on the first list.

8. The apparatus according to claim 7, further being caused to:
update the first list periodically or upon determining to initiate the handover for the target user node.

9. The apparatus according to claim 7, further being caused to:
generate a second list indicating, per link of a plurality of links between the plurality of user nodes, a first value indicating the tolerable latency of the link, and a second value indicating the latency of the link, wherein the subset of the plurality of user nodes is selected based at least partly on the second list.

10. The apparatus according to claim 9, further being caused to:
update the second list based on a link being added to or removed from the plurality of links, or based on a user node being added to or removed from the plurality of user nodes.

11. The apparatus according to claim 1, further being caused to:
determine whether the subset of the plurality of user nodes comprises at least one edge function; and
based on determining that the subset comprises the at least one edge function, transmit, to the target access point, information comprising attributes and stored data associated with the at least one edge function.

12. The apparatus according to claim 1, wherein the plurality of user nodes comprises at least one of the following: a plurality of user devices, or one or more edge functions and one or more user devices.

13. The apparatus according to claim 1, wherein the apparatus, the plurality of access points, and the plurality of user nodes are in a same subnetwork.

14. (canceled)

15. A method comprising:
determining, by an apparatus, whether a handover of a target user node of a plurality of user nodes would cause a latency of one or more links between the target user node and one or more other user nodes of the plurality of user nodes to be larger than a tolerable latency;
selecting, by the apparatus, based at least partly on the determination, a subset of the plurality of user nodes for the handover, wherein the subset comprises at least the target user node;
selecting, by the apparatus, a target access point from a plurality of access points for the handover; and
transmitting, by the apparatus, to the subset of the plurality of user nodes, an indication for performing the handover from the apparatus to the target access point.

16. (canceled)

17. A system comprising at least a target user node and an access point of a wireless communication network;
wherein the access point is configured to:
determine whether a handover of the target user node of a plurality of user nodes would cause a latency of one or more links between the target user node and one or more other user nodes of the plurality of user nodes to be larger than a tolerable latency;
select, based at least partly on the determination, a subset of the plurality of user nodes for the handover, wherein the subset comprises at least the target user node;
select a target access point from a plurality of access points for the handover; and
transmit, to the subset of the plurality of user nodes, an indication for performing the handover from the access point to the target access point;
wherein the target user node is configured to:
receive the indication from the access point; and
perform, based on the indication, the handover from the access point to the target access point.
